(19) United States
(12) Patent Application Publication
(10) Pub. No.: US 2021/0178670 A1
(43) Pub. Date: Jun. 17, 2021

(54) ADDITIVE MANUFACTURING SYSTEMS AND METHODS OF FORMING COMPONENTS USING SAME

(71) Applicant: Research Foundation for State University of New York, Albany, NY (US)

(72) Inventors: Gregory Denbeaux, Albany, NY (US); Bridget V. Boland, Colonie, NY (US)

(21) Appl. No.: 17/121,617

(22) Filed: Dec. 14, 2020

Related U.S. Application Data
(60) Provisional application No. 62/947,359, filed on Dec. 12, 2019.

(51) Int. Cl. B29C 64/165; B29C 64/209; B29C 64/393; B29C 64/268; B29C 64/314; B33Y 40/10

(52) U.S. Cl. CPC B29C 64/165; B29C 64/209; B29C 64/393; B33Y 10/00; B29C 64/314; B33Y 40/10; B29C 64/268

(57) ABSTRACT

Additive manufacturing systems that disperses an at least partially liquid state build material to form a component. The system may include a material conduit including a first section in direct fluid communication with a material supply, and a second section in fluid communication with the first section. The build material flowing through the second section of the material conduit may include at least a portion in a liquid state. The system may also include a nozzle in direct fluid communication with the second section of the material conduit, and a build chamber including a cavity receiving at least a portion of the nozzle. The cavity may include a predetermined pressure during a build process.

### CROSS-REFERENCE TO RELATED APPLICATION

This application claims the benefit of priority of U.S. Application No. 62/947,359, filed Dec. 12, 2019, which is incorporated by reference herein in its entirety.

### BACKGROUND

The disclosure relates generally to additive manufacturing systems, and more particularly, to additive manufacturing systems that disperses an at least partially liquid state build material to form a component.

Components or parts for various machines and mechanical systems may be built using additive manufacturing systems. Conventional additive manufacturing systems may build such components by continuously layering powder material in predetermined areas and performing a material transformation process, such as sintering or melting, on the powder material. The material transformation process may alter the physical state of the powder material from a granular composition to a solid material to build the component. The components built using the additive manufacturing systems have nearly identical physical attributes as conventional components typically made by performing machining processes (e.g., material removal processes) on stock material. However, because of the advantageous process, the components formed using additive manufacturing may include unique features and/or complex geometries that are difficult or impossible to obtain and/or build using conventional machining processes.

While able to manufacture complex geometries that are unattainable over conventional machining process, conventional additive manufacturing may still be limited in its ability to create certain features or shapes. For example, components made using conventional material deposition processes (e.g., powder deposition) must be able to be made linearly based on the processes and/or machine capabilities of the system. Furthermore, conventional material deposition processes and systems require extensive amounts of material to be deposited to form a part, which results in an increase in material cost and production or creation time. Additionally, some components with unique features may require the formation of disposable supports or struts to support those features of the components. These supports are removed from the component post additive manufacturing and simply discarded, creating added waste to these conventional additive processes.

To overcome some of the identified difficulties and negatives to deposition-based additive manufacturing, direct-energy deposition, such as electron beam additive manufacturing (EBAM), may be used. In one example, conventional direct-energy deposition may deposit a material on a surface of the component and immediately exposed to an energy stream to form a layer of the component. Alternatively in another example, material may be directed directly at the energy stream (e.g., electron beam), which in turn may direct the heated/transformed (e.g., solid state to liquid state) material to the component to form a layer or portion of the component. While able to create additional complex geometries, conventional direct-energy deposition is time consuming, expensive, creates additional material waste (e.g., material not properly deposited or passing through beam without deposition), and often results in inaccuracies and/or defects formed in the component due to outside influences (e.g., material flowing out of beam stream, undesirable suction/pressure, etc.). Furthermore, the geometries created in the components using conventional direct-energy deposition is limited by the inability to move the energy device and/or material deposition device freely when creating the component.

### BRIEF DESCRIPTION

A first aspect of the disclosure provides an additive manufacturing system including: a material supply including a build material; a material conduit in fluid communication with the material supply, the material conduit including: a first section in direct fluid communication with the material supply, the first section receiving the build material from the material supply flowing through at least a portion of the first section of the material conduit in a vapor state, and a second section in fluid communication with the first section and receiving the build material from the first section, at least a portion of the build material flowing through the second section is in a liquid state; a coolant conduit in fluid communication with material conduit, the coolant conduit in fluid communication with a coolant supply for receiving a coolant material from the coolant supply; a nozzle in direct fluid communication with the second section of the material conduit; and a build chamber including a cavity receiving at least a portion of the nozzle, the cavity having a predetermined pressure.

A second aspect of the disclosure provides a method of forming a component using an additive manufacturing system. The method includes: flowing a build material through a first section of a material conduit of the additive manufacturing system; flowing the build material through a second section of the material conduit to a nozzle of the additive manufacturing system, the second section of the material conduit in fluid communication with and positioned between the first section of the material conduit and the nozzle, wherein at least a portion of the build material flowing through the second section is in a liquid state; and dispersing the build material from the nozzle onto a build substrate positioned within a cavity of a build chamber of the additive manufacturing system, the cavity having a predetermined pressure.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a schematic view of an additive manufacturing system, according to embodiments of the disclosure.

FIG. 2 shows an enlarged view of a build material dispersed by the additive manufacturing system of FIG. 1 to form a component, according to embodiments of the disclosure.

FIG. 3 shows an enlarged view of a build material dispersed by the additive manufacturing system of FIG. 1 to form a component, according to other embodiments of the disclosure.

FIG. 4 shows a schematic view of an additive manufacturing system, according to additional embodiments of the disclosure.

FIG. 5 shows a schematic view of an additive manufacturing system, according to another embodiment of the disclosure.

FIG. 6 shows an enlarged view of a build material dispersed by the additive manufacturing system of FIG. 5 to form a component, according to embodiments of the disclosure.

FIG. 7 shows a schematic view of an additive manufacturing system, according to further embodiments of the disclosure.

FIG. 8 shows a schematic view of an additive manufacturing system including a supplemental material supply system, according to embodiments of the disclosure.

FIG. 9 shows a cross-sectional view of a portion of a component build using an additive manufacturing system, according to embodiments of the disclosure.

FIGS. 10A and 10B show a flowchart illustrating a process for building a component using an additive manufacturing system, according to embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

As an initial matter, in order to clearly describe the current disclosure it will become necessary to select certain terminology when referring to and describing relevant machine components within the disclosure. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

As discussed herein, the disclosure relates generally to additive manufacturing systems, and more particularly, to additive manufacturing systems that disperses an at least partially liquid state build material to form a component.

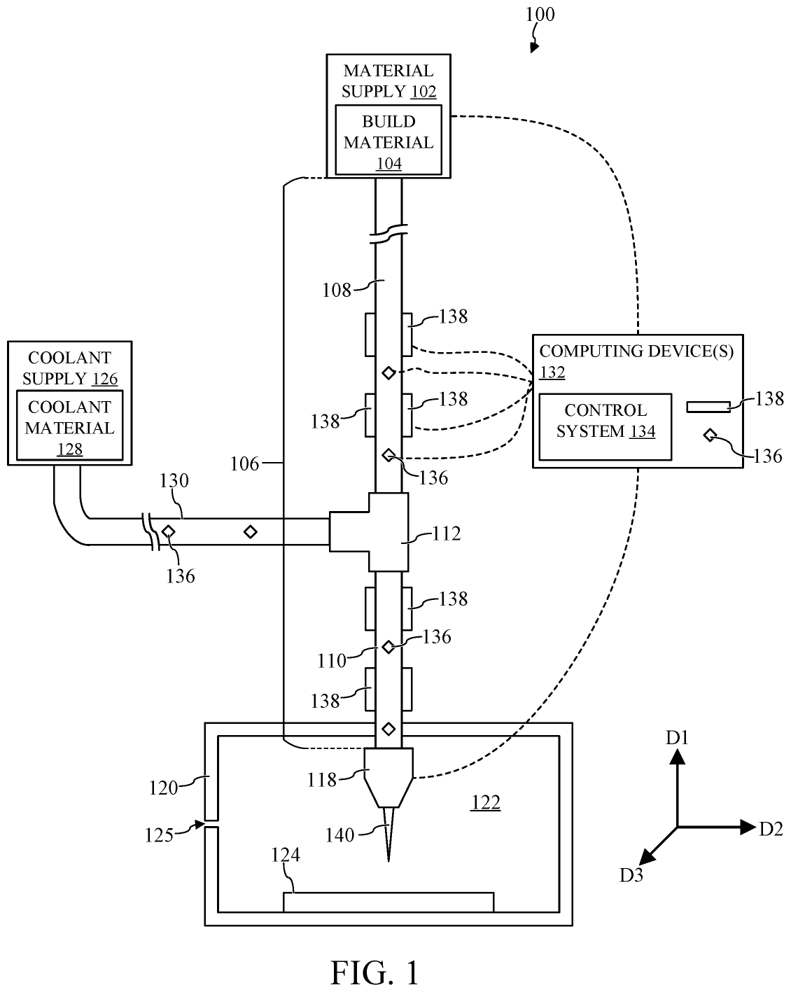

These and other embodiments are discussed below with reference to FIGS. 1-10B. However, those skilled in the art will readily appreciate that the detailed description given herein with respect to these Figures is for explanatory purposes only and should not be construed as limiting.

FIG. 1 shows a schematic view of an additive manufacturing system 100 (hereafter, “AMS 100”). AMS 100 may be used to form, build, and/or create a component from a build material, as discussed herein. In a non-limiting example, AMS 100 may include a material supply 102. Material supply 102 may be formed as any suitable component that may be configured to receive, contain, and/or hold a build material 104 that may be utilized in the build process to form the component, as discussed herein. For example, material supply 102 may be formed from a tank, container, vessel, receptacle, chamber, hopper and/or the like. In other non-limiting examples, material supply 102 may be configured to provide build material 104 to other portions of AMS 100 (e.g., material conduit) during the build process using any suitable means including, but not limited to, gravity feed or an auxiliary supply system or source that provides gas flow (e.g., carrier fluid/gas) or suction (not shown) to move build material 104 through AMS 100, as discussed herein. Additionally, and as discussed herein, build material 104 included within material supply 102 may be in either a solid state, a liquid state, or a vapor state. As such, material supply 102 may also include additional devices and/or apparatuses, for example a heating element (e.g., not shown), to ensure that build material 104 may be transformed and/or maintained at the desired physical state (e.g., solid, liquid, vapor). Furthermore, build material 104 may include any suitable material that may be heated and cooled during the build process as discussed herein to form a component using AMS 100. For example, build material 104 may be formed from materials including, but not limited to, metals, metal-alloys, polymers (e.g., silicones), and/or the like.

AMS 100 may also include a material conduit 106. Material conduit 106 may be in fluid communication with material supply 102 to receive build material 104 from material supply 102. In the non-limiting example shown in FIG. 1, material conduit 106 of AMS 100 may include two distinct portions or sections 108, 110. More specifically, material conduit 106 may include a first section 108 in direct fluid communication with material supply 102, and a second section 110 in fluid communication with the first section 108. As shown in FIG. 1, first section 108 and second section 110 of material conduit 106 may be formed as two distinct components that may be (fluidly) coupled using a T-connection or joint 112. In other non-limiting examples first section 108 and second section 110 may be formed as a single component and/or may be formed integral to one another. Material conduit 106 may be formed from any suitable material that may allow build material 104 to flow therethrough, as well as withstand the temperature/heating during the process of forming a component using AMS 100, as discussed herein. For example, material conduit 106 may be formed from metal, metal-alloys, ceramic, fiberglass, polymers, and/or the like. Additionally, each section 108, 110 of material conduit 106 may be formed from the same or distinct materials. For example, first section 108 of material conduit 106 may be formed from a ceramic material, while second section 110 may be formed from a metal or metal-alloy material.

As shown in FIG. 1, AMS 100 may include a nozzle 118 in communication with material conduit 106. More specifically, nozzle 118 may be in direct fluid communication with second section 110 of material conduit 106. As discussed herein, at least a portion of nozzle 118 may be positioned within a build chamber 120 when building the component using AMS 100. Nozzle 118 may be formed as any suitable device and/or apparatus that may be configured to disperse, dispense, and/or distribute build material 104 within the build chamber to create, form, and/or build a component using AMS 100. Additionally, nozzle 118 may also be shaped and/or configured to converge near the tip/exit opening, such that build material 104 flowing through nozzle 118 may be pressurized and/or accelerated out of nozzle 118 when dispersed therefrom in forming the component. That is, and as discussed herein, in order for build material 104 to be dispersed from nozzle 118 at a high rate of speed/at high pressure during the build process, the pressure upstream of the nozzle 118 opening may be greater than the pressure downstream of the opening (e.g., after discharge from nozzle 118). The shape and/or configuration of nozzle 118 may, at least in part, aid in the pressure distribution within AMS 100. Similar to material conduit 106, nozzle 118 may be formed from any suitable material that may allow build material 104 to flow therethrough, as well as withstand the temperature of build material 104 flowing therethrough during the process of forming a component using AMS 100. For example, nozzle 118 may be formed from metal, metal-alloys, ceramic, fiberglass, polymers, and/or the like. In the non-limiting example shown in FIG. 1, nozzle 118 may also be configured to move, traverse, and/or rotate in each of a first direction (D1), a second direction (D1), and third direction (D3) (e.g., in-and-out of the page). Nozzle 118 may use or include any suitable system, apparatus, and/or device that may allow nozzle 118 to move and/or rotate in the identified directions including, but not limited to, a flexible joint (not shown) coupling nozzle 118 to second section 110 of material conduit 106 and/or a moveable arm (not shown) coupled to nozzle 118 and/or material conduit 106.

Build chamber 120 of AMS 100 may be formed adjacent to and/or may receive at least a portion of nozzle 118. More specifically, and as shown in the non-limiting example of FIG. 1, build chamber 120 may include and/or may define a cavity 122 which may receive at least a portion of nozzle 118 during the build process, as discussed herein. Cavity 122 of build chamber 120 may also receive a build substrate 124. Substrate 124 may receive build material 104 and/or provide a base or build plate for the component build, formed, and/or created by AMS 100 during the build process. Cavity 122 of build chamber 120 may be configured to be substantially sealed to have or maintain a predetermined (internal) pressure during the build process. For example during the build process, cavity 122 may include a predetermined pressure that is less than atmospheric pressure (e.g., sub-atmospheric). The predetermined pressure may include between approximately zero (0) atmospheres (atm) and below one (1) atm (e.g., 0.5 atm). Build chamber 120 may also include an opening or exhaust portion 125 that may be used to maintain the internal pressure in cavity 122, as well as dissipate and/or remove gas(es)/particles from chamber 120 during the build process. In a non-limiting example, a vacuum (not shown) may be in fluid communication with exhaust portion 125 to remove the carrier fluid that moves build material 104 through material conduit 106, and/or maintain the desired pressure within chamber 120. The inclusion of the exhaust portion 125/removal of carrier fluid may, at least in part, aid in maintaining the desired pressure within build chamber 120 to optimize the deposition of build material 104 on substrate 124 when forming the component using AMS 100, as discussed herein.

As discussed herein, nozzle 118 may be configured to move, traverse, and/or rotate in directions (D1, D2, D3) when forming the component using AMS 100. Additionally, or alternatively, build chamber 120, and more specifically build substrate 124 positioned within cavity 122, may be configured to move, traverse, and/or rotate in directions (D1, D2, D3) when forming the component using AMS 100.

AMS 100 may also include a coolant supply 126. Coolant supply 126 may be formed as any suitable component that may be configured to receive, contain, and/or hold a coolant material 128 that may be utilized in the build process to form the component (e.g., cool build material 104), as discussed herein. For example, coolant supply 126 may be formed from a tank, container, vessel, receptacle, chamber, hopper and/or the like. In other non-limiting examples, coolant supply 126 may be configured to provide coolant material 128 to other portions of AMS 100 (e.g., coolant conduit) during the build process using any suitable means including, but not limited to, gravity feed or an auxiliary supply system or source that provides gas flow or suction (not shown) to move coolant material 128 through AMS 100, as discussed herein.

AMS 100 may also include a coolant conduit 130. Coolant conduit 130 may be in fluid communication with coolant supply 126 to receive coolant material 128 from coolant supply 126. Additionally, and as shown in the non-limiting example of FIG. 1, coolant conduit 130 of AMS 100 may also be in fluid communication with material conduit 106. More specifically, coolant conduit 130 may be in direct fluid communication with second section 110 of material conduit 106 via T-connection 112. As discussed herein, coolant conduit 130 may supply coolant material 128 to second section 110 of material conduit 106 to cool and/or reduce the temperature of build material 104 flowing from first section 108 to second section 110 of material conduit 106 prior to build material 104 being dispersed by nozzle 118. In the non-limiting example, coolant conduit 130 may be in direct fluid communication such that coolant material 128 may be provided directly to second section 110 of material conduit 106 to directly contact, mix with, and consequently cool build material 104 flowing therethrough. Coolant conduit 130 may be formed from any suitable material that may allow coolant material 128 to flow therethrough. For example, coolant conduit 130 may be formed from metal, metal-alloys, ceramic, fiberglass, polymers, and/or the like. Furthermore, coolant material 128 may include any suitable material that may be used to cool build material 104 during the build process as discussed herein. For example, coolant material 128 may be formed from materials including, but not limited to, argon, nitride, oxides, and/or the like.

AMS 100 may also include at least one computing device 132 configured to control operations of distinct, components, devices, and/or apparatuses of AMS 100. Computing device(s) 132 may be hard-wired, wirelessly and/or operably connected to and/or in communication with various components of AMS 100 via any suitable electronic and/or mechanic communication component or technique. Specifically, computing device(s) 132 may be in electrical communication and/or operably connected to material supply 102, nozzle 118, and coolant supply 126 (not shown) of AMS 100. Computing device(s) 132, and its various components discussed herein, may be a single stand-alone system that functions separate from an operations system of AMS 100 (e.g., computing device) (not shown) that may control and/or adjust at least a portion of operations and/or functions of AMS 100, and its various components (e.g., nozzle 118). Alternatively, computing device(s) 132 and its components may be integrally formed within, in communication with and/or formed as a part of a larger control system of AMS 100 (e.g., computing device)(not shown) that may control and/or adjust at least a portion of operations and/or functions of AMS 100, and its various components.

In various embodiments, computing device(s) 132 can include a control system 134 for controlling operations and/or functions of AMS 100 during the build process. As discussed herein control system 134 can control the movement of nozzle 118 of AMS 100, and/or the flow of build material 104 being dispersed by nozzle 118 during the build process. Additionally, control system 134 may also control the output and/or flow of build material 104 from material supply 102 and/or coolant material 128 from coolant supply 126 during the build process. Furthermore, and as discussed herein, control system 134 may control the operation of heaters included in AMS 100 to ensure build material 104 is in a desired physical state (e.g., gas, liquid, solid) and/or includes a desired temperature as it flows through material conduit 106.

As shown in FIG. 1, computing device(s) 132 may include and/or may be in electrical and/or mechanical communication with at least one sensor 136 positioned throughout, within, adjacent to and/or around AMS 100. In the non-limiting example, sensor(s) 136 may be positioned directly within first section 108 and second section 110 of material conduit 106, as well as directly within coolant conduit 130. In other non-limiting examples, sensor(s) 136 may be positioned directly adjacent to, in communication with, and/or may be coupled to an outside of first section 108 of material conduit 106, second section 110 of material conduit 106, and coolant conduit 130. Sensor(s) 136 of AMS 100 may be any suitable sensor configured to detect and/or determine a temperature of build material 104 and coolant material 128 flowing through AMS 100. More specifically, sensor(s) 136 of AMS 100 may be any suitable sensor that may detect and/or determine a first temperature of build material 104 in a gas or vapor state flowing through first section 108 of material conduit 106, a second temperature of build material 104 in a liquid and solid state flowing through second section 110 of material conduit 106, and a temperature of coolant material 128 flowing through coolant conduit 130. In another non-limiting example where sensor(s) 136 are in communication with and/or coupled to conduits 106, 130, sensor(s) 136 may be any suitable sensor that may detect and/or determine the temperature of the respective conduits 106, 130, which in turn may allow computing device(s) 132/control system 134 to calculate the temperature of build material 104 and coolant material 128 flowing through AMS 100. In non-limiting examples, sensor(s) 136 may be configured as, but not limited to, thermometers, thermistor, thermocouples, and/or any other mechanical/electrical temperature sensor. As discussed herein, determining the temperatures of build material 104 flowing through material conduit 106 and coolant material 128 flowing through coolant conduit 130 may aid in the formation of the component using AMS 100.

Although two sensors 136 are shown in each section 108, 110/conduit 130, it is understood that in another non-limiting example, AMS 100 may include only one sensor 136, so long as sensor(s) 136 may be configured to provide computing device(s) 132, and specifically control system 134, with information or data relating to temperatures of build material 104/coolant material 128, as discussed herein. The number of sensors 136 shown in FIG. 1 is merely illustrative and non-limiting. As such, AMS 100 may include more or less sensors 136 than what is depicted in the Figures. Additionally, although computing device(s) 132 is only shown in FIG. 1 as being connected to and/or in electronic communication with a portion of sensors 136 of AMS 100, it is understood that computing device(s) 132 may be in electronic communication with each sensor(s) 136 included in AMS 100.

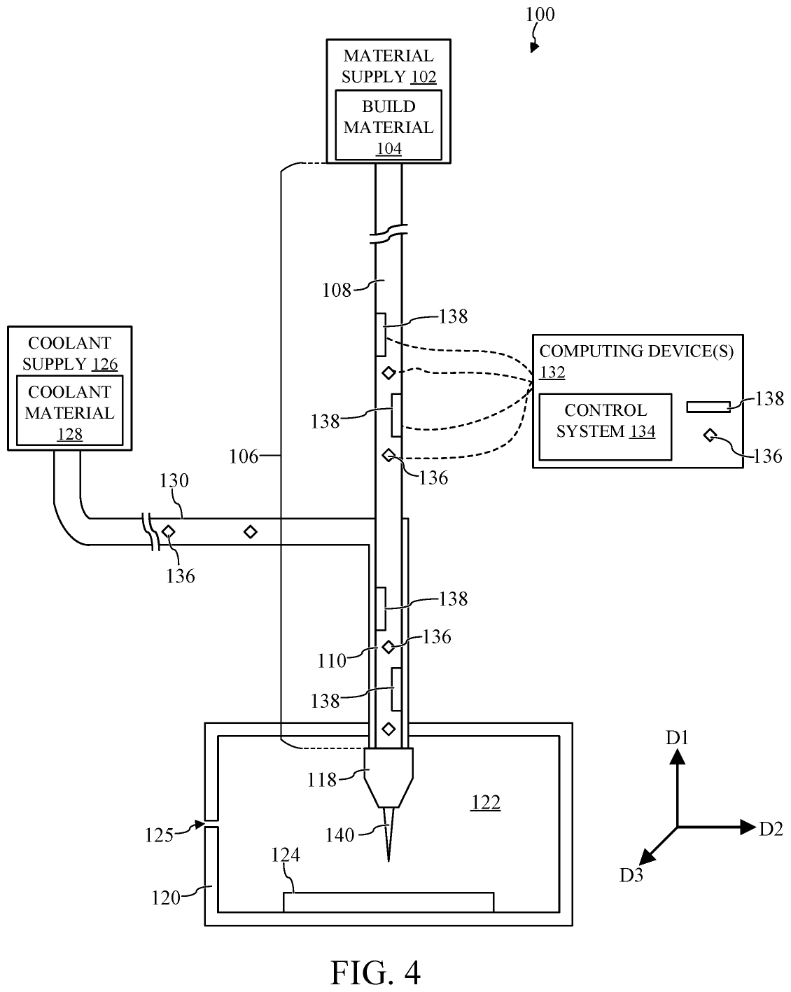

AMS 100 may also include at least one heater 138. That is, computing device(s) 132 may include and/or may be in electrical and/or mechanical communication with at least one heater 138 positioned throughout, within, adjacent to, and/or around AMS 100. In the non-limiting example shown in FIG. 1, heater(s) 138 may be positioned directly adjacent to, in communication with, and/or may be coupled to an outside of first section 108 of material conduit 106, and second section 110 of material conduit 106, respectively. In another non-limiting example (see, FIG. 4), heater(s) 138 may be positioned directly within first section 108 and second section 110 of material conduit 106. Heater(s) 138 of AMS 100 may be any suitable heating device configured to generate and/or emit heat in AMS 100. More specifically, heater(s) 138 of AMS 100 may be any suitable heating device that may generate and/or emit heat to increase the temperature of build material 104 flowing through material conduit 106. In the non-limiting example where heater(s) 138 are in communication with and/or coupled to the outside of material conduit 106, heater(s) 138 may be any suitable heating device that may generate and/or emit heat material conduit 106, which in turn may increase a temperature and/or maintain a temperature for build material 104 flowing therethrough. In another non-limiting example where heater(s) 138 are positioned directly within material conduit 106, heater(s) 138 may be any suitable heating device that may generate and/or emit heat that may directly increase a temperature and/or maintain a temperature for build material 104 flowing through material conduit 106 and/or over heater(s) 138. In non-limiting examples, heater(s) 138 may be configured as, but not limited to, ohmic heating devices, inductive heating devices, laser heating devices, and so on. As discussed herein, maintaining and/or adjusting the temperature of build material 104 using heater(s) 138 may aid in the formation of the component using AMS 100.

Although two heaters 138 are shown in each section 108, 110 of material conduit 106, it is understood that in another non-limiting example, AMS 100 may include more or less sensors 136 than what is depicted in the Figures. As such, the number of heaters 138 shown in FIG. 1 is merely illustrative. Additionally, although computing device(s) 132 is only shown in FIG. 1 as being connected to and/or in electronic communication with a portion of heaters 138 of AMS 100, it is understood that computing device(s) 132 may be in electronic communication with each heater(s) 138 included in AMS 100.

The process of building a component on substrate 124 using AMS 100 is now discussed herein. Initially, build material 104 may be provided in material supply 102, and a coolant material 128 may be provided to coolant supply 126. As discussed herein, build material 104 may be provided to and contained within material supply 102 at a liquid and/or solid state, and may be subsequently heated and/or vaporized within material conduit 106. Alternatively, build material 104 may be vaporized by and/or provided to material supply 102 in a vapor state prior to flowing through material conduit 106.

In a non-limiting example, build material 104 may be copper (Cu), which includes a melting temperature of approximately 1084 Celsius (° C.). In one example, the copper may be deposited into and maintained in material supply 102 of AMS 100 in a liquid and/or solid state. In another non-limiting example, the copper may be deposited into and/or maintained in material supply 102 in a gaseous or vapor state.

Prior to providing build material 104 to material conduit 106, material conduit 106 may be preheated. That is, in order to prevent undesirable phase change of build material 104 as it flows through first section 108 of material conduit 106, first section 108 and second section 110 of material conduit 106 may be preheated to a desired temperature using heater(s) 138. The preheat-predetermined temperature for first section 108 and second section 110 of material conduit 106 may be dependent upon the first predetermined temperature for build material 104 in first section 108 and the second predetermined temperature for build material 104 in second section 110. The first predetermined temperature and the second predetermined temperature for build material 104 associated with the desired phase (e.g., gas/liquid/solid) of build material 104 within each respective section 108, 110, as discussed herein. In a non-limiting example, first section 108 may be preheated to a first predetermined temperature which may either vaporize build material 104 within first section 108 and/or maintain build material 104 flowing through first section 108 in a vaporized state dependent upon the phase of build material 104 within material supply 102. Additionally, second section 110 may be preheated to a second predetermined temperature, lower than the first predetermined temperature, which may alter or aid in the change in phase of build material 104 from a vaporized or gaseous state to a liquid/solid state.

Continuing the example herein, prior to providing the copper to material conduit 106, first section 108 and second section 110 of material conduit 106 may be preheated. More specifically, first section 108 and/or the internal space of first section 108 may be heated to a first predetermined temperature, while second section 110 and/or the internal space of second section 110 may be heated to a second predetermined temperature that is lower than the first predetermined temperature. For example, first section 108 of material conduit 106 may be preheated to approximately 1,500° C. to convert and/or maintain the copper in a gaseous/vapor state as it flow therethrough. Additionally, second section 110 of material conduit 106 may be preheated to approximately 1,200° C. to convert and/or maintain the copper in a liquid and/or solid state as it flows therethrough.

Once material conduit 106 is preheated, build material 104 may be provided to material conduit 106. Specifically, after first section 108 and second section 110 of material conduit 106 are preheated to the respective predetermined temperatures, material supply 102 may provide build material 104 to material conduit 106. In a non-limiting example where build material 104 is contained in material supply 102 in a vapor state, build material 104 may be provided, supplied and/or flow through first section 108 of material conduit 106 in the vapor state and may be maintained in the vapor state throughout first section 108 by heater(s) 138 heating first section 108 to the predetermined temperature. In another non-limiting example where build material 104 is provided to first section in a liquid/solid state, build material 104 may be provided to first section 108 of material conduit 106 and subsequently transformed to a vapor state. That is, and using heater(s) 138 to heat first section 108 to the first predetermined temperature, build material 104 may be transformed from liquid/solid state to a vapor state within first section 108 as it flows therethrough. As discussed herein, the first predetermined temperature in which heater(s) 138 may heat first section 108 to may convert and/or maintain build material 104 in a gaseous/vapor state. Sensor(s) 136 in communication with computing device(s) 132 may continuously or intermittently determine the temperature of build material 104 and/or the internal temperature of material conduit 106 in order to determine how much heat and/or energy heater(s) 138 must emit to ensure build material 104 is in a vapor state as it flows through first section 108 and/or first section 108 is heated to the first predetermined temperature.

Build material 104 in vapor/gaseous state may flow from first section 108 to second section 110 prior to being deposited within build chamber 120. In the non-limiting example, as build material 104 flows through second section 110 it may be converted to a liquid state and/or a solid state. More specifically, the vapor/gaseous state build material 104 may flow from first section 108 to second section 110 of material conduit 106, via T-connection 112, and may be cooled within second section 110. The cooling of build material 104 within second section 110 may result in the altering and/or converting of vapor/gaseous state build material 104 to liquid/solid state build material 104 prior to build material being dispersed by nozzle 118. That is, where second section 110 of material conduit 106 is kept at and/or includes a lower temperature (e.g., second predetermined temperature) than the temperature of first section 108 (e.g., first predetermined temperature), build material 104 flowing to and/or within second section 110 may be substantially cooled. The second predetermined temperature may be below of vaporization temperature, but still above a melting temperature of the material forming build material 104. As such, and when build material 104 flows into second section 110, the build material 104 may be cooled and the phase may be converted from gaseous/vapor to a combination of liquid state material and solid-state material, or alternatively may be substantially all liquid state material. The closer to the first predetermined temperature for second section 110 is to the melting temperature of build material 104 and/or the closer build material 104 is cooled to the melting temperature, the greater the percentage or amount of solid-state build material 104 may be formed in second section 110.

To aid in the cooling of build material 104 within second section 110 of material conduit 106, coolant material 128 may also be provided as well. More specifically, coolant conduit 130 in direct fluid communication with second section 110 of material conduit 106 via T-connection 112 may provide coolant material 128 from coolant supply 126 directly to second section 110 to cool build material 104 flowing therethrough. In this non-limiting example, coolant material 128 may directly contact and/or interact with build material 104 flowing through second section 110 to quench, cool, and/or reduce the temperature of build material 104. Additionally, coolant material 128 may aid in the conversion of build material 104 from the vapor/gaseous state to the liquid and/or solid state within second section 110 of material conduit 106. Coolant material 128, in conjunction with heater(s) 138 in communication with second section 110, may ensure build material 104 is cooled to a temperature that allows for the conversion of the material from the vapor/gaseous state to the liquid and/or solid state, but maintains build material 104 at a temperature above a melting temperature for the material.

In the example where the build material is copper, first section 108 may be heated and/or maintained at the first predetermined temperature that may ensure the copper is at a temperature at or above 1,500° C., as it flows therein. This in turn may convert and/or maintain the copper in a gaseous/vapor state as it flows through first section 108. Subsequently, the vaporized/gaseous copper material may flow to the second section of material conduit 106 which may result in the cooling of the copper material. That is, second section 110 may be heated and/or maintained at the second predetermined temperature, lower than the first predetermined temperature, that may ensure the copper is cold to a temperature that converts the gaseous copper to liquid and/or solid-state copper. Additionally, second section 110 may be heated and/or maintained at the second predetermined temperature to maintain the copper at a temperature that is above the melting temperature of copper (e.g., 1084° C.). In another non-limiting example, a calculated amount of coolant material 128 (at a calculated temperature) may be introduced and/or flowed to second section 110 to aid in the cooling of the copper and/or the converting of the gaseous state copper to the liquid and/or solid-state copper. In the non-limiting example, the coolant material 128 may be formed as oxygen (O₂).

From second section 110, build material 104 may flow through and/or be dispersed by nozzle 118. More specifically, build material 104, in the liquid and/or sold state, may flow from second section 110 and may be dispersed, dispensed, and/or distributed by the nozzle 118. The build material 104 dispersed by nozzle 118 may be final build material 140, that may be accelerated toward and/or build up on substrate 124 to form a desired component. Nozzle 118 may continuously or intermittently flow final build material 140 toward substrate 124 to build the desired component using AMS 100. Additionally, and as discussed herein, nozzle 118 may move in various directions (e.g., D1, D2, D3) to build the component and its various features using final build material 140.

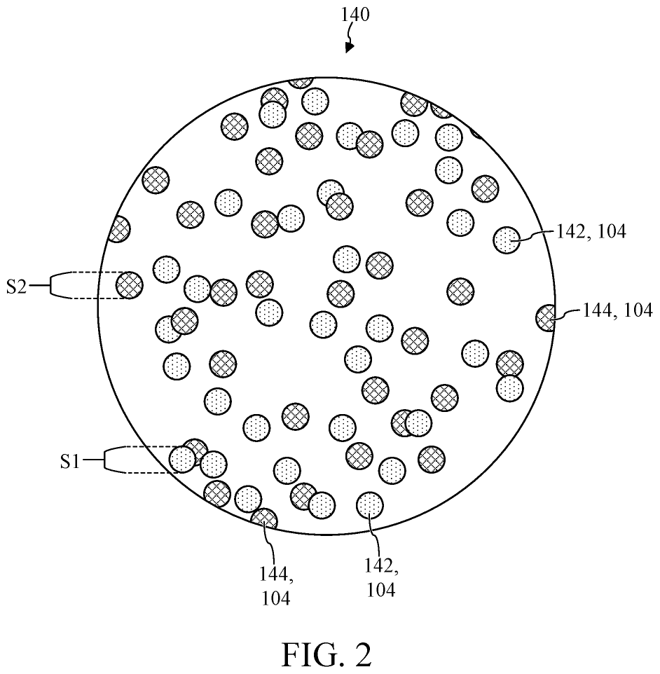

Turning to FIG. 2, an enlarged view of final build material 140 is shown. In a non-limiting example, and as discussed herein, final build material 140 received by nozzle 118 from second section 110 may include both liquid state material 142 and solid-state material 144. As discussed herein, liquid state material 142 may be formed from, formed as, and/or referred to as “droplets,” while solid state material 144 may be formed from, formed as, and/or referred to as “particles.” The amount of each state and/or the ratio between the amount of liquid state material 142 and solid-state material 144 may be dependent at least in part on the temperature of build material 104 after it is cooled and/or flows to nozzle 118. More specifically, and as discussed herein, the closer build material 104 is cooled to the melting temperature, the greater the percentage or amount of solid-state material 144 may be present in final build material 140. The ratio between the amount of liquid state material 142 and solid-state material 144 in final build material 140 may be between approximately 100:0 and 20:80. In another non-limiting example, substantially all of final build material 104 may include or be comprised of liquid state material 142. In either example, build material 140 may contact substrate 124 (or previous deposited final build material 140) and liquid state material 142 and solid-state material 144 may combine to form the component. Additionally, liquid state material 142 of final build material 140 may also solidify instantaneously or within a predetermined time (e.g., less than a second) to bind solid-state material 144 and/or form the component.

The porosity and/or (material) density of the component built using liquid state material 142 and/or solid-state material 144 of final build material 140 may be dependent, at least in part, by the ratio of liquid state material 142 and solid-state material 144 deposited on substrate 124. That is, the porosity and/or density of the component built by AMS 100 may be determined, affected, and/or influenced by the ratio of liquid state material 142 and solid-state material 144 for final build material 140 forming the component. In a non-limiting example, the porosity of the component may decrease and the density of the component may increase as the amount of liquid state material 142 in final build material 140 increases. As discussed herein, the amount of liquid state material 142 may increase and/or may be influenced by the temperature in which build material 104 is cooled to in second section 110 (e.g., more liquid state material 142 in final build material 140 when the temperature of build material 104 is further from the melting point in second section 110). In another non-limiting example, the porosity of the component may increase and the density of the component may decrease as the amount of liquid state material 142 in final build material 140 decreases (e.g., build material 104 cooled closed to melting point in second section 110).

As shown in FIG. 2, each of liquid state material 142 and solid-state material 144 of final build material 140 may include a size (S1, S2) or dimension (e.g., droplet/particle size or dimension). The size (S1) of liquid state material 142 (e.g., droplet size) in final build material 140 may be substantially equal to or distinct from the size (S2) of solid-state material 144 (e.g., particle size). Additionally, the size (S1, S2) of each of liquid state material 142 and/or solid-state material 144 for final build material 140 may be substantially uniform, or alternatively, may include a desired range. The size (S1, S2) of each of liquid state material 142 (droplet) and/or solid-state material 144 (particles) for final build material 140 may be dependent, at least in part, on the cooling rate for build material 104 in second section 110 of material conduit 106. That is, and briefly returning to FIG. 1, the cooling rate for build material 104, which includes the temperature and time difference in cooling build material 104 from the first temperature in first section 108 to the second (lower) temperature in second section 110, may affect, influence, and/or determine the size (S1, S2) of liquid state material 142 and solid-state material 144. The higher the cooling rate for build material 104 in second section 110 of material conduit 106, the smaller the size (S1, S2) (e.g., droplet/particle size) for each of liquid state material 142 and/or solid-state material 144 of final build material 140. As such, increasing a cooling rate for build material 104 in second section 110 may result in a decrease in (droplet/particle) size (S1, S2) for liquid state material 142 and/or solid-state material 144 of final build material 140. Alternatively, decreasing the cooling rate for build material 104 in second section 110 may result in an increase in (droplet/particle) size (S1, S2) for liquid state material 142 and/or solid-state material 144 of final build material 140. The size of the droplets forming liquid state material 142 and/or the particles forming solid-sate material 144 of final build material 140 may be between, for example, approximately 10 nanometers (nm) to 100 micron (μm).

Additionally, porosity of the component built using AMS 100 may also be influenced, at least in part, by the size (S1, S2) of liquid state material 142 and/or solid-state material 144 of final build material 140. For example, the size (S1, S2) of liquid state material 142 and/or solid-state material 144 of final build material 140 may also influence, affect, and/or determine the size and/or shape of the “holes” or “openings” formed in a porous component built using AMS 100.

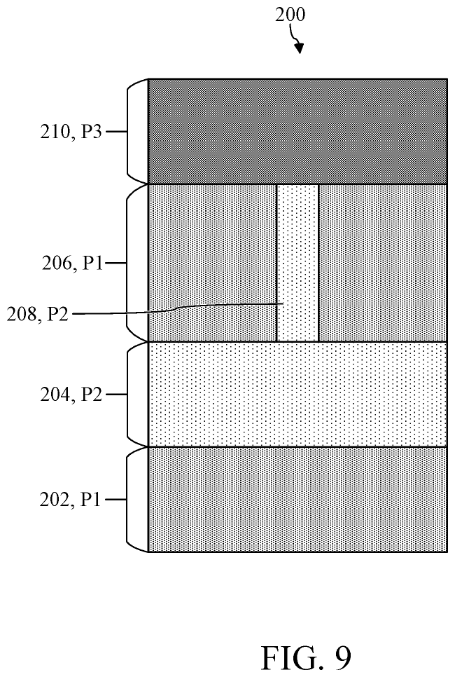

Component built on substrate 124 by AMS 100 may have predetermined and/or desired build characteristics, which may include predetermined size of particles, a predetermined density, a predetermined porosity, and/or predetermined build patterns or features. As discussed herein, computing device 132, using sensor(s) 136, may obtain and/or calculate data (e.g., temperatures for build material 104) relating to the build process, and adjust the operation of portions of AMS 100 (e.g., heater(s) 138) to ensure the component is built to specification. For example, where the component includes two portions having distinct porosities (see, FIG. 9), AMS 100 may operate under first operational conditions to form the first portion including the first porosity. AMS 100 may then alter its operation, in near real-time, to second operational conditions to form the second portion including the second porosity. Where the second porosity is greater than the first porosity, the altered operational conditions may include, but are not limited to, decreasing the temperature in which build material 104 is cooled in second section 110 of material conduit 106, which in turn may decrease the amount of liquid state material 142 in final build material 140.

Additionally in this example, if it is desired to keep the droplet/particle size (S1, S2) for each of liquid state material 142 and solid-state material 144 the same between the first portions and the second portions, then the temperature of build material 104 in first section 108 may also be reduced, and/or the amount of coolant material 128 supplied to second section 110 may be increased. In altering these operational conditions the cooling rate for build material 104 may remain the same when forming the first portion having the first porosity and the second portion having the second porosity.

Although discussed herein as converting build material 104 from vapor to liquid state material 142 (and solid-state material 144) within material conduit 106, it is understood that at least a portion of build material 104 may remain as liquid state material 142 from material supply 102 to nozzle 118. That is, and in another non-limiting example, build material 104 may be contained in material supply 102 in a liquid state. Liquid-state material 142 forming build material 104 may flow to first section 108 of material conduit 106 and may be heated, but may not be converted and/or changed to a vapor/gaseous state. Rather in this non-limiting example, build material 104 flowing through first section 108 may remain in the liquid state and heated to the first predetermined temperature—a temperature below the identified temperature that would convert build material 104 to a vapor/gaseous state. As such, liquid-state material 142 of build material 104 may flow from first section 108 of material conduit 106 to second section 110, and may subsequently cooled to the second, predetermined and/or desired temperature (e.g., above melting temperature) as similarly discussed herein. However in this non-limiting, and because build material 104 flowing through first section 108 of material conduit 106 is already in a liquid state, build material 104 may not undergo a conversion process from vapor/gaseous state to liquid/solid state. Rather, build material 104 may remain substantially as liquid state material 142 before being dispersed by nozzle 118. Alternatively, a portion of liquid state material 142 flowing from first section 108 to second section 110 may be converted from liquid state material 142 to solid-state material 144 within second section 110 prior to being dispersed by nozzle 118, as discussed herein.

In this non-limiting example, liquid state material 142 of build material 104 may be provided and/or flowed from material supply to first section 108 of material conduit 106 using any suitable device and/or process to generate and/or create droplets that may flow via an aerosol affect. For example, an ultrasonic device or system (not shown) may be included or in communication with material supply 102. In this example, the ultrasonic device may provide an ultrasonic pulse to build material 104 that in turn may form, generate, and/or separate build material 104 within material supply 102 to include a predetermined droplet size (e.g., S1, 10 nm to 100 μm). Once formed to include the predetermined droplet size, liquid stat material 142 of build material 104 may flow and/or be moved to first section 108 of material conduit 106 using the processes and/or features discussed herein (e.g., suction, carrier fluid, etc.).

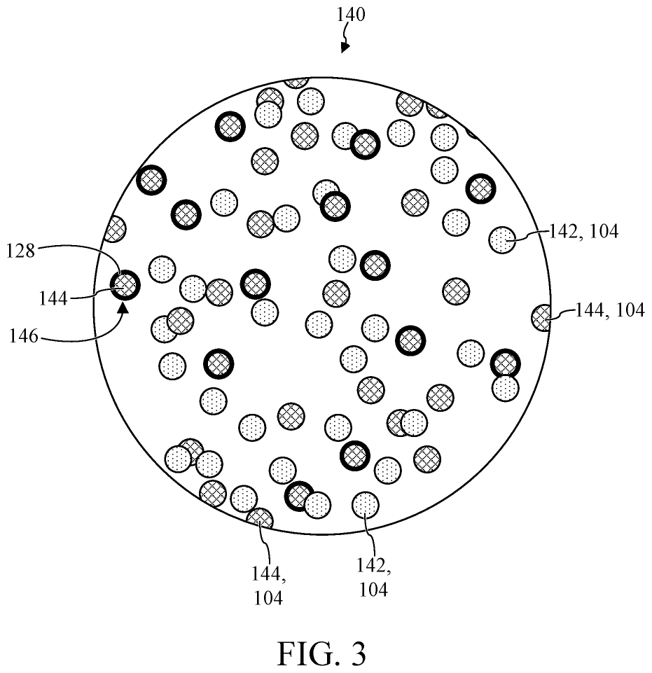

FIG. 3 shows another non-limiting example of an enlarged view of final build material 140. Final build material 140 shown in FIG. 3 may formed and/or used within AMS 100 substantially similar to final build material 140 shown and discussed herein with respect to FIG. 2. It is understood that similarly numbered and/or named components may function in a substantially similar fashion. Redundant explanation of these components has been omitted for clarity.

Distinct from final build material 140 shown in FIG. 2, final build material 140 may include a distinct material. That is, final build material 140 shown in FIG. 3 may include both liquid state material 142 and solid-state material 144, both formed from converting and/or altering the phase of build material 104 as discussed herein. In additional final build material 140 may also include a distinct compound material 146. Compound material 146 included in final build material 140 may be formed within material conduit 106 during the heating/cooling/phase change processes. For example, compound material 146 may be generated, created, and/or formed as a result of a chemical interaction and/or chemical reaction between coolant material 128 and build material 104 within second section 110 of material conduit 106. That is, coolant material 128 may interact with liquid/solid-state material or droplets/particles of build material 104 within second section 110 of material conduit 106, and may form a compound material that is chemically and/or physically distinct material from the material forming build material 104. In one example build material 104 is formed from copper (Cu) and a coolant material 128 may be formed from nitrogen (N). In the example shown in FIG. 3, all liquid state material 142 and a portion of solid-state material 144 of final build material 140 may be and/or may remain copper (Cu) in final build material 140. However, a portion of the solid-state material 144 of final build material 140 may include and/or be formed as copper(I) nitride (Cu₃N). The inclusion of compound material 146 within final build material 140 may alter or change the physical, chemical, and/or mechanical properties (e.g., composition, strength, ductility, and so on) of the component formed using AMS 100, as discussed herein.

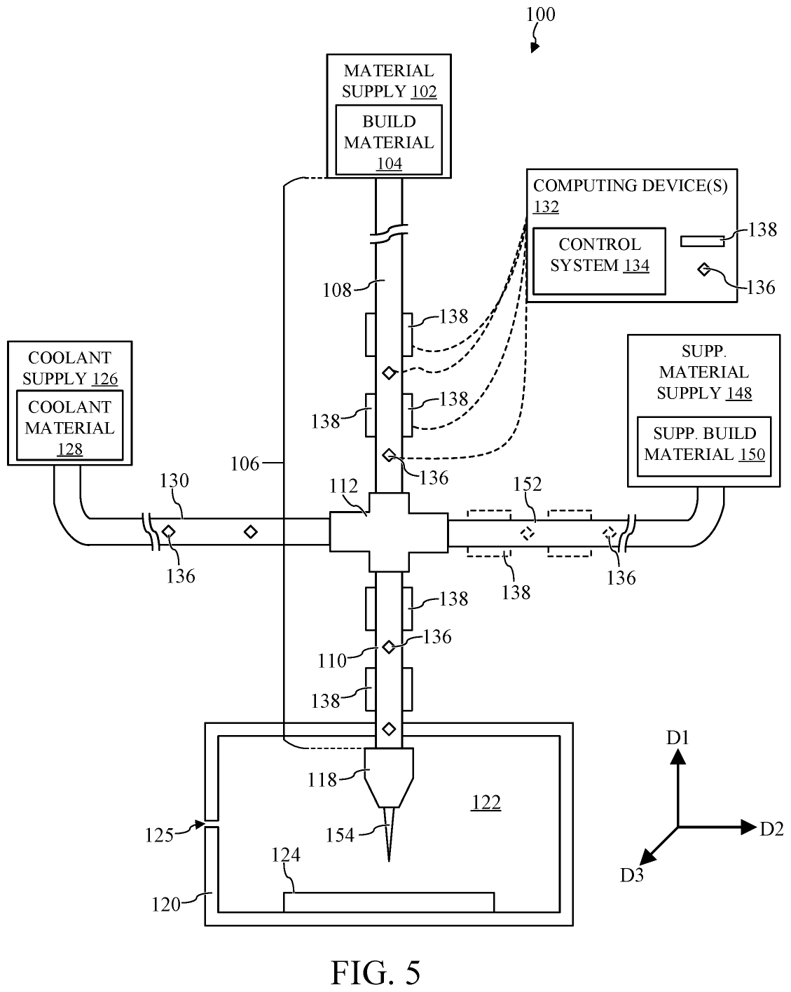

FIGS. 4 and 5 show additional non-limiting example of AMS 100. More specifically, FIGS. 4 and 5 depict schematic views of other examples of AMS 100. It is understood that similarly numbered and/or named components may function in a substantially similar fashion. Redundant explanation of these components has been omitted for clarity.

The non-limiting example of AMS 100 shown in FIG. 4 may include distinct features and/or configurations in comparison to AMS 100 shown and discussed herein with respect to FIG. 1. For example, heater(s) 138 may be positioned within material conduit 106. More specifically, heater(s) 138 electrically coupled to computing device(s) 132 may be positioned directly within first section 108 and second section 110 of material conduit 106. In the non-limiting example, heater(s) 138 may be contacted directly by build material 104 flowing through material conduit 106. As such, heater(s) 138 may not only heat or emit heat directly in the internal portion of material conduit 106 as well as heat material conduit 106, but may also heat build material 104 directly.

Additionally in FIG. 4, coolant conduit 130 may include a distinct configuration. For example, coolant conduit 130 may not be in direct fluid communication with material conduit 106. Rather, coolant conduit 130 may substantially surround and/or encompass second section 110 of material conduit 106. As a result, coolant material 128 flowing through coolant conduit 130 may not directly contact build material 104 to cool and/or reduce the temperature, as discussed herein. Rather, coolant conduit 130 may provide coolant material 128 to contact and/or substantially surround second section 110 of material conduit 106 to cool build material 104 flowing therein. That is, coolant conduit 130 may cool or reduce the temperature of second section 110 of material conduit 106, which in turn may aid in the cooling of build material 104 and/or the converting of build material 104 from gaseous/vapor phase to liquid and/or solid state.

In the non-limiting example shown in FIG. 5, AMS 100 may include additional components. For example, AMS 100 may also include a supplemental material supply 148. Supplemental material supply 148 may be formed as any suitable component that may be configured to receive, contain, and/or hold a supplemental build material 150 that may be utilized in the build process to form the component, as discussed herein. For example, supplemental material supply 148 may be formed from a tank, container, vessel, receptacle, chamber, hopper and/or the like. In other non-limiting examples, supplemental material supply 148 may be configured to provide supplemental build material 150 to other portions of AMS 100 (e.g., supplemental material conduit) during the build process using any suitable means including, but not limited to, gravity feed or an auxiliary supply system or source that provides gas flow or suction (not shown) to move supplemental build material 150 through AMS 100, as discussed herein.

AMS 100 may also include a supplemental material conduit 152. Supplemental material conduit 152 may be in fluid communication with supplemental material supply 148 to receive supplemental build material 150. Additionally, and as shown in the non-limiting example of FIG. 5, supplemental material conduit 152 of AMS 100 may also be in fluid communication with material conduit 106. More specifically, supplemental material conduit 152 may be in direct fluid communication with second section 110 of material conduit 106 via T-connection 112. As discussed herein, supplemental material conduit 152 may supply supplemental build material 150 to second section 110 of material conduit 106 to mix, be added, and/or interact with build material 104 flowing through second section 110 of material conduit 106. Supplemental material conduit 152 may be formed from any suitable material that may allow supplemental build material 150 to flow therethrough. For example, supplemental material conduit 152 may be formed from metal, metal-alloys, ceramic, fiberglass, polymers, and/or the like. Furthermore, supplemental build material 150 may include any suitable material that may be mixed, added, and/or interact with build material 104 during the build process to alter the physical and/or mechanical properties of the component build using AMS 100, as discussed herein. For example, supplemental build material 150 may be formed from materials including, but not limited to, metals, metal-alloys, polymers (e.g., silicones), ceramics, and/or the like.

As a result of adding supplemental build material 150 to build material 104 within material conduit 106 during the build process, final build material 154 may be distinct from final build material 140 shown and discussed herein with respect to FIGS. 1 and 2. For example, where supplemental build material 150 includes a ceramic material, final build material 154 dispersed, dispensed, and/or distributed by nozzle 118 to form the component on substrate 124 may include additional material, elements, and/or compositions.

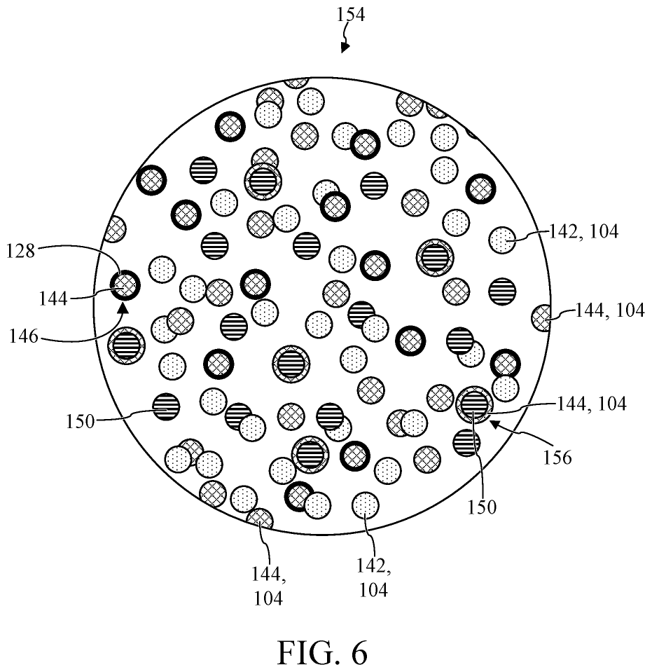

Turning to FIG. 6, and with continued reference to FIG. 5, final build material 154 may include both liquid state material 142 and solid-state material 144 formed from build material 104, as well as compound material 146, as discussed herein. Additional final build material 154 may also include distinct particles of supplemental build material 150 (e.g., ceramic). Furthermore in some non-limiting examples, final build material 154 may include distinct compound materials 156. Distinct compound material 156 included in final build material 154 may be formed within material conduit 106 during the heating/cooling/phase change processes. For example, distinct compound material 156 may be generated, created, and/or formed as a result of a interaction and/or reaction between build material 104 and supplemental build material 150 within second section 110 of material conduit 106. Distinct compound materials 156 may include a combination of build material 104 and supplemental build material 150. Specifically, and as shown in FIG. 6, distinct compound materials 156 may include supplemental build material 150 substantially surrounded, coated, and/or enclosed by build material 104. Build material 104 in a liquid state material 142 in second section 110 of material conduit 106 may become coupled/affixed to supplemental build material 150, and substantial surround supplemental build material 150. The temperature of supplemental build material 150 may subsequently (further) cool build material 104 to convert surrounding build material 104 to the solid-state, as shown in FIG. 6.

In one example, build material 104 is formed from copper (Cu) and supplemental build material 150 may be formed from silicone carbide (SiC). In the example shown in FIG. 6, solid state copper material may substantial surround and/or enclose the silicone carbide to form the distinct compound material 156. The inclusion of distinct compound material 156 within final build material 154 may alter or change the physical, chemical, and/or mechanical properties (e.g., composition, strength, ductility, and so on) of the component formed using AMS 100, as discussed herein.

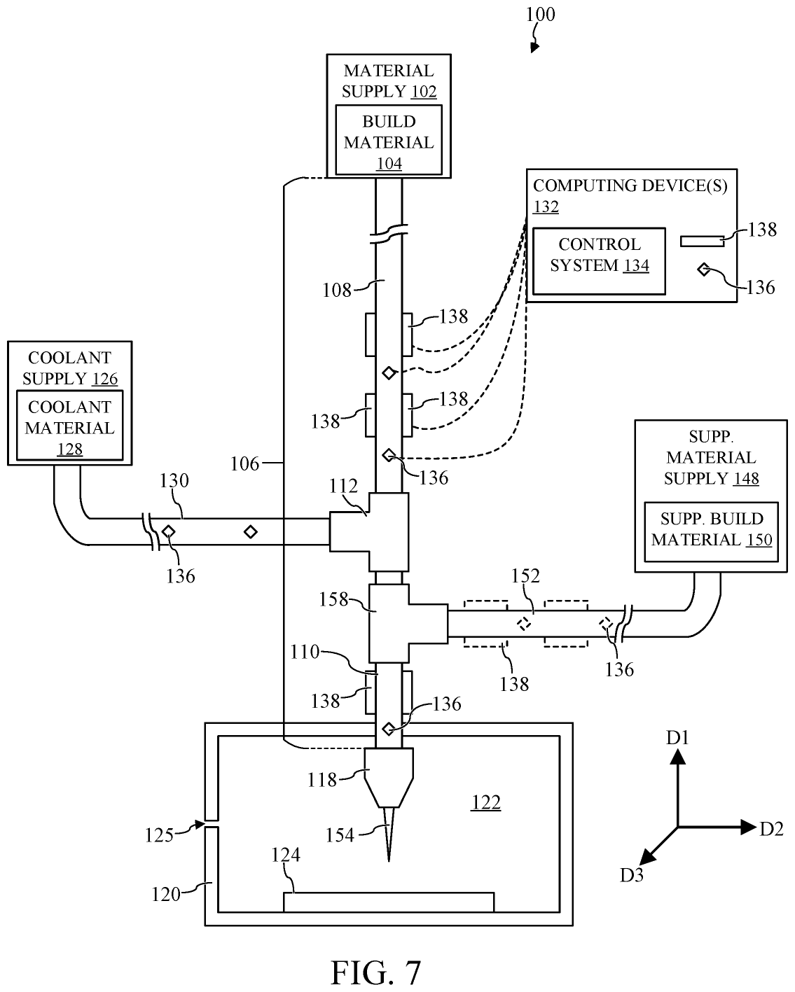

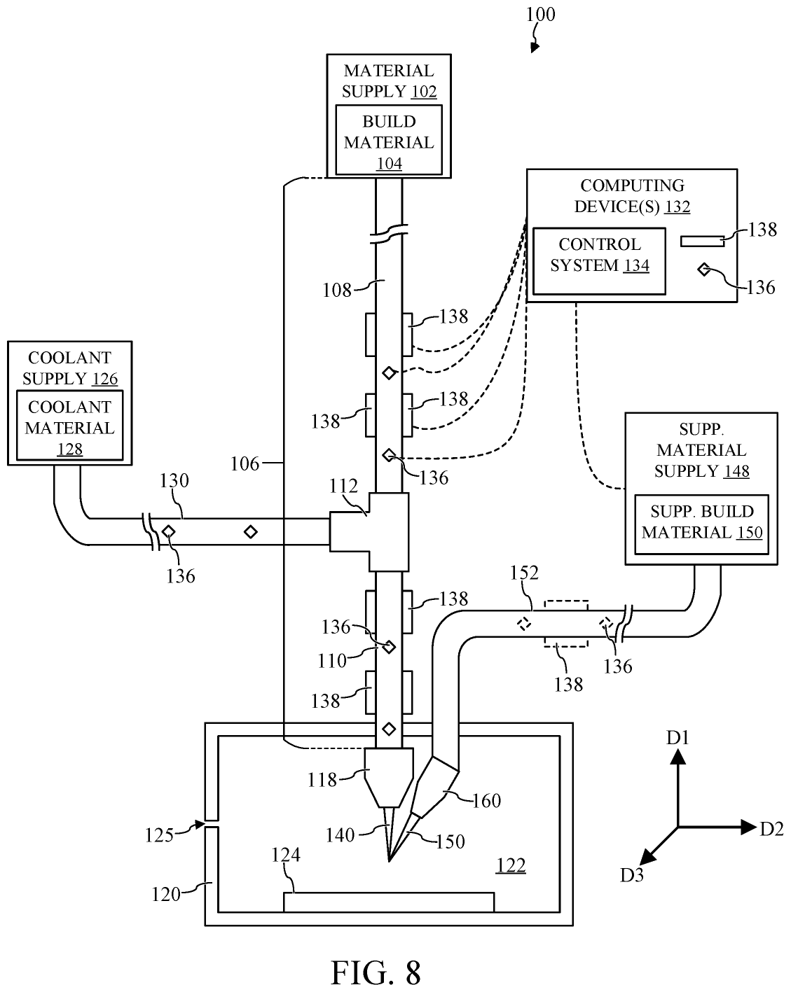

FIGS. 7 and 8 show additional non-limiting example of AMS 100. More specifically, FIGS. 7 and 8 depict schematic views of other examples of AMS 100 including the implementation of supplemental build material 150 therein. It is understood that similarly numbered and/or named components may function in a substantially similar fashion. Redundant explanation of these components has been omitted for clarity.

The non-limiting example of AMS 100 shown in FIG. 7 may include distinct features and/or configurations in comparison to AMS 100 shown and discussed herein with respect to FIG. 5. For example, while supplemental material supply 148 may still be in fluid communication with second section 110 of material conduit 106, it may not be via T-connection 112. Rather, supplemental material conduit 152 may be in direct fluid communication with second section 110 of material conduit 106 via a distinct T-connection 158. Distinct T-connection 158 may be positioned and/or in communication with material conduit 106 downstream of T-connection 112, and/or directly adjacent nozzle 118. In the non-limiting example, and based on the position of supplemental material conduit 152, supplemental build material 150 may be mixed with build material 104 immediately prior to flowing to and subsequently being dispersed by nozzle 118.

In another non-limiting example (not shown), Distinct T-connection 158 may be positioned and/or in communication with material conduit 106 upstream of T-connection 112, and/or opposite nozzle 118. In the non-limiting example, supplemental material conduit 152 may be in direct fluid communication with first section 108 or second section 110 of material conduit 106—dependent upon how close distinct T-connection 158 is positioned on material conduit 106 to material supply 102. Where supplemental material conduit 152 is in fluid communication with first section 108 of material conduit 106, supplemental build material 150 may be provided with gaseous/vapor state build material 104 in first section 108. However, where supplemental build material 150 is formed from a material having a higher melting point (e.g., ceramic), supplemental build material 150 may not undergo a phase change even when provided to first section 108 of material conduit 106.

FIG. 8 shows another non-limiting example of AMS 100. In the non-limiting example, AMS 100 may include supplemental material supply 148, supplemental build material 150, and supplemental material conduit 152 as similarly described herein. However, and distinct from AMS 100 shown and discussed herein with respect to FIGS. 5 and 7, supplemental material conduit 152 may not be in fluid communication with material conduit 106 of AMS 100. Rather, supplemental material conduit 152 may be in fluid communication with a distinct or supplemental nozzle 160. That is, AMS 100 may include supplemental nozzle 160 in direct fluid communication with supplemental material conduit 152. Similar to nozzle 118, at least a portion of supplemental nozzle 160 may be positioned within cavity 122 of build chamber 120. Additionally, supplemental nozzle 160 may be positioned adjacent nozzle 118 within build chamber 120. In the non-limiting example, supplemental nozzle 160 may disperse, distribute, and/or dispense supplemental build material 150 directly into final build material 140 dispensed by nozzle 118. That is, and based on the position of supplemental nozzle 160 within AMS 100, supplemental build material 150 may be mixed, combined, and/or added to final build material 140 within cavity 122 of build chamber 120, and ultimately included in the formation of the component using AMS 100. As similarly discussed herein, supplemental build material 150 dispensed by supplemental nozzle 160 may be mixed, added, and/or interact with final build material 140 during the build process to alter the physical and/or mechanical properties of the component build using AMS 100, as discussed herein. Also similar to nozzle 118, supplemental nozzle 160 may be formed from any suitable material that may allow supplemental build material 150 to flow therethrough, and may also be configured to move, traverse, and/or rotate in each of a first direction (D1), a second direction (D1), and third direction (D3) (e.g., in-and-out of the page).

FIG. 9 shows an enlarged cross-sectional view of a component 200 made using AMS 100 shown and discussed herein with respect to FIG. 1, 4, 5, 7, or 8. In the non-limiting example, component 200 may include a single, unitary body that may be formed via the build material (e.g., final build material 140) deposition processes discussed herein. As shown in FIG. 9, component 200 may include various sections 202, 204, 206, 210. The sections 202, 204, 206, 210 depicted in FIG. 9 and discussed herein are all integrally formed and/or make up unitary body for component 200. As such, it is understood that the distinctions in sections (e.g., identifying lines and borders) are provided for illustration.

Each section 202, 204, 206, 210 may include similar and/or distinct features and/or properties. That is, each of the plurality of sections 202, 204, 206, 210 may be formed by depositing final build material 140, 154 on substrate 124 of AMS 100 (see, FIG. 1). In a non-limiting example, each section 202, 204, 206, 210 may be formed from using the same build material. Alternatively in another non-limiting example, each section 202, 204, 206, 210 may be formed with the same foundational build material (e.g., final build material 140), but each layer may include additional material. For example, first section 202 may be formed solely with build material 104/final build material 140 (e.g., free of compound material 146). Distinct from first section 202, second section 204 may also include compound material 146. Fourth section 210 may include final build material 140, compound material 146, and supplemental build material 150.

In another non-limiting example, each section 202, 204, 206, 210 may include a distinct porosity. That is, first section 202 may include a first porosity (P1), second section 204 may include a second porosity (P2), and fourth section 210 may include a third porosity (P3), where each porosity (P1, P2, P3) is distinct from one another. Additionally as shown in FIG. 9, third section 206 may include two different porosities (P1, P2). That is, the majority of third section 206 may include a first porosity (P1) similar to first section 202, but may include a desired feature 208 formed therein that may include a second porosity (P2) similar to that of second section 204. Based on the formation and/or build process discussed herein, it is understood that AMS 100 may build integrally formed component 200 with the distinct sections 202, 204, 206, 210 including features 208 by simply changing operational conditions, characteristics, and/or parameters (e.g., rate of cooling, temperature of build material 104 in second section 110 of material conduit 106, introduction of coolant material 128, etc.) during the build process.

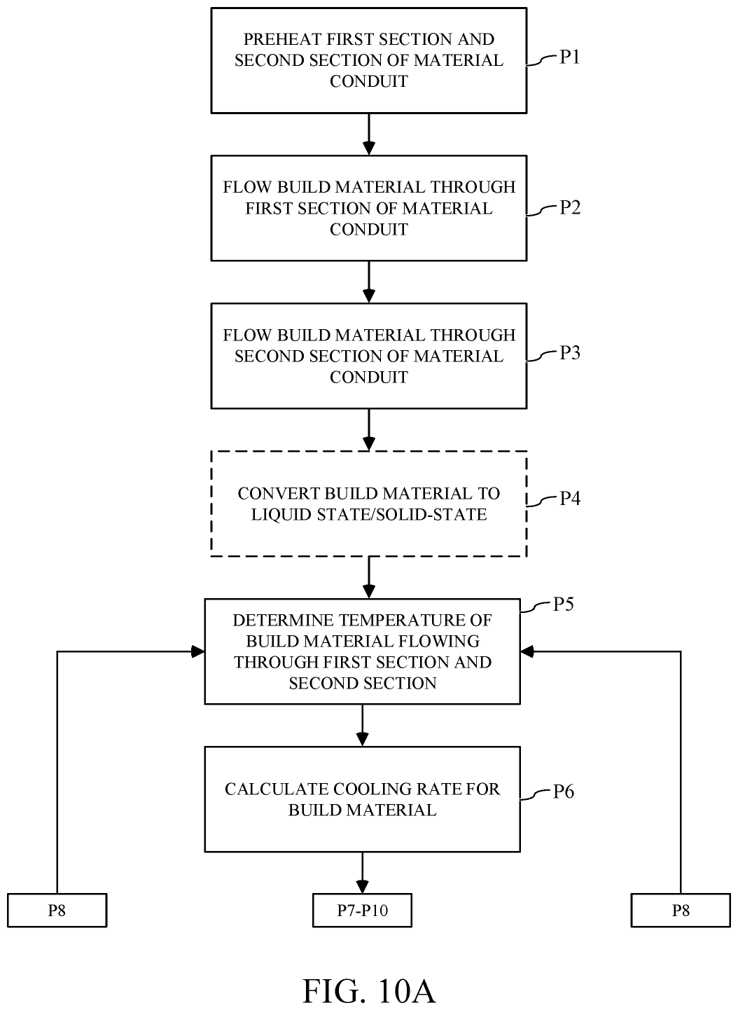

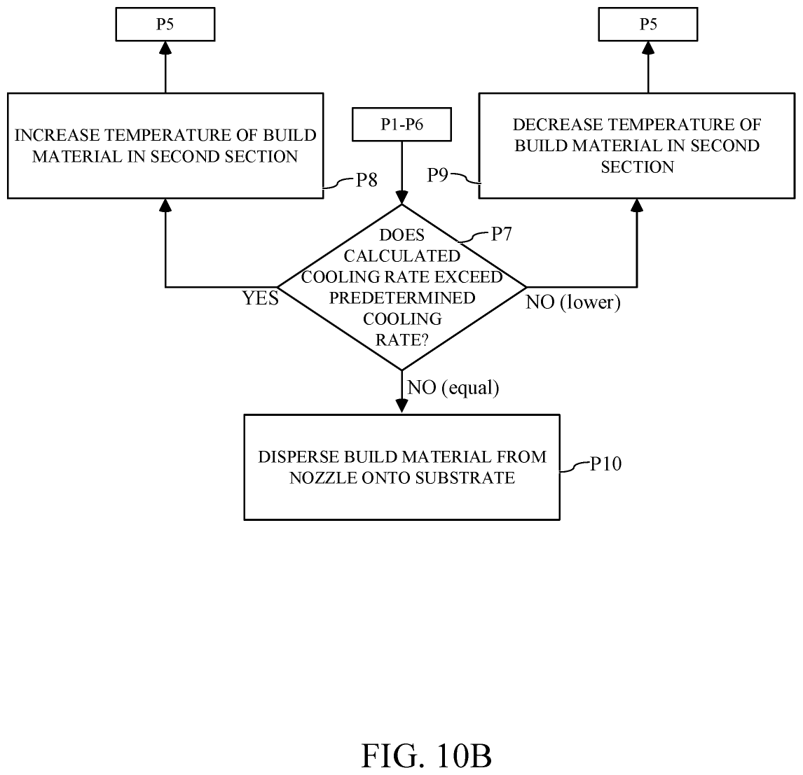

FIGS. 10A and 10B depicts example processes for building a component using an additive manufacturing system. In some cases, an additive manufacturing system may be used to form the component, as discussed above with respect to FIGS. 1, 4, 5, 7, and 8.

In process P1 a material conduit of an AMS may be preheated. More specifically, a first section of a material conduit may be preheated to a first predetermined temperature, and a second section of the material conduit may be preheated to a second predetermined temperature, where the second predetermined temperature is lower than the first predetermined temperature. In the non-limiting example, the first predetermined temperature may be associated with a temperature that may convert and/or maintain a build material at a vapor or gaseous state. Additionally, the second predetermined temperature may be associated with a temperature that may convert and/or maintain the build material from the vapor or gaseous stage to a liquid state and/or a solid-state. The second predetermined temperature may also be above a melting temperature for the build material. In another non-limiting example where at least a portion of the build material remains in a liquid state during the build process, the first predetermined temperature and the second predetermined temperature may be above a melting temperature for the build material, where the first predetermined temperature is higher than the second predetermined temperature, but below a temperature that may convert and/or maintain a build material at a vapor or gaseous state.

In process P2 the build material may flow through the first section of the material conduit. In non-limiting examples, the build material flowing through the first section of the material conduit may be converted to and/or may be maintained at a gaseous or vapor state. In another non-limiting example, he build material flowing through the first section of the material conduit may remain in a liquid state.

In process P3 the build material may flow through the second section of the material conduit. More specifically, the build material may flow from the first section of the material conduit to the second section of the material conduit.

In process P4, shown in phantom as optional, the build material flowing through the second section of the material conduit may be converted to and/or may be maintained at a liquid state and/or solid state. In a non-limiting example, the build material may be converted in the second section of the material conduit from a gaseous or vapor state to a liquid state. In another non-limiting example, the build material flowing through the second section of the material conduit may be converted to and/or may be maintained at a combination of a liquid state and a solid state, where the converted material includes a ratio or amount of liquid and solid-state material. In a further non-limiting example, at least a first portion of the build material flowing through the second section of the material conduit may be converted to and/or may be maintained in a solid state, while a second portion may remain in the liquid state. That is, where the build material is in a liquid state in the first section of the material conduit, only a portion of the liquid state material flowing from the first section to the second section may be converted and/or remain in a solid-state—the remainder may stay in liquid form. Converting the build material from the vapor or gaseous state to a liquid and/or solid state may also include cooling the build material flowing through the second section of the material conduit to a predetermined temperature prior to flowing the build material to a nozzle for dispersion. The predetermined may be a temperature above the melting point of the build material. Process P4 may not be performed in the instance where the entirety of the build material is to remain in the liquid state as it flows from the first section of the material conduit to the second section.

In process P5, the temperature of the build material may be determined in the material conduit. More specifically, a first temperature of the build material flowing through the first section of the material conduit may be determined, and a second temperature of the build material flowing through the second section of the material conduit may be determined. As a result of converting/cooling the build material in the second section, the determined second temperature of the build material may be lower than the determined first temperature.

In process P6, a cooling rate for build material may be calculated. More specifically, and based upon the determined first and second temperature of the build material (e.g., process P5), a cooling rate for the build material flowing through the material conduit may be calculated. The cooling rate may include the temperature and time difference in cooling the build material from the first determined temperature in the first section to the second (lower) temperature in the second section.

In process P7, it may be determined if the calculated cooling rate exceeds a predetermined cooling rate. The predetermined cooling rate may be associated with desired characteristics of the build material that forms the component using AMS, and/or may relate to build characteristics and/or properties for the component built using the AMS. For example, the predetermined cooling rate may be associated with the size of the droplets/particles for the build material in the liquid and/or solid state flowing through the second section of the material conduit. The size of the droplets/particles in the liquid and/or solid state may further define the shape and size of the holes or openings formed in the component that is substantially porous.

In response to determining that the calculated cooling rate exceeds or is below (e.g., not equal to) the predetermined cooling rate, operational characteristics and/or parameters of the AMS forming the component may be adjusted. For example, in response to determining that the calculated cooling rate does exceed the predetermined cooling rate (e.g., “YES” at process P7), the temperature of the build material may be increased in the second section of the material conduit in process P8. That is, the AMS may increase the temperature of the build material flowing through the second section of the material conduit in response to determining that the calculated cooling rate is higher than or exceeds a predetermined cooling rate for the build material. In a non-limiting example, the temperature of the build material flowing through the second section may be increased by increasing the second temperature of the second section of the material conduit. Additionally, increasing the temperature of the build material flowing through the second section of the material conduit may further include reducing the calculated cooling rate for the build material, and/or increasing the droplet/particle size of the build material flowing through the second section of the material conduit in the liquid state and/or solid state. Once the temperature of the build material in the second section of the material conduit is increased, the temperature of the build material may be determined again (e.g., process P5).

In response to determining that the calculated cooling rate does not exceed (and is lower than) the predetermined cooling rate (e.g., “NO (lower)” at process P7), the temperature of the build material may be decreased in the second section of the material conduit in process P9. That is, the AMS may decrease the temperature of the build material flowing through the second section of the material conduit in response to determining that the calculated cooling rate is lower than a predetermined cooling rate for the build material. In a non-limiting example, the temperature of the build material flowing through the second section may be decreased by decreasing the second temperature of the second section of the material conduit. Additionally, decreasing the temperature of the build material flowing through the second section of the material conduit may further include increasing the calculated cooling rate for the build material, and/or decreasing the droplet/particle size of the build material flowing through the second section of the material conduit in the liquid state and/or solid state. Further, the temperature of the build material flowing through the second section of the material conduit may be decrease by reducing an amount of heat supplied to the second section of the material conduit, and/or increase an amount of coolant material supplied to the second section of the material conduit. Once the temperature of the build material in the second section of the material conduit is decreased, the temperature of the build material may be determined again (e.g., process P5).

In response to determining that the calculated cooling rate does not exceed (and is equal to) the predetermined cooling rate (e.g., “NO (equal)” at process P7), the build material may be dispersed onto a substrate in process P10 to form a component. More specifically, the build material including a calculated cooling rate that is equal to the predetermined cooling rate may be dispersed, dispensed, and/or distributed by a nozzle of the AMS to form the component on a substrate of the AMS. Dispersing the build material from the nozzle onto a substrate to form the component may also include adjusting a position of the nozzle during the dispersing to form a feature and/or distinct portions of the component using the build material.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s). “Fluid” discussed herein, unless identified to a specific material state or phase, may refer to liquid or gas.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. An additive manufacturing system comprising:
a material supply including a build material;
a material conduit in fluid communication with the material supply, the material conduit including:
a first section in direct fluid communication with the material supply, the first section receiving the build material from the material supply, and
a second section in fluid communication with the first section and receiving the build material from the first section, at least a portion of the build material flowing through the second section is in a liquid state;
a coolant conduit in fluid communication with material conduit, the coolant conduit in fluid communication with a coolant supply for receiving a coolant material from the coolant supply;
a nozzle in direct fluid communication with the second section of the material conduit; and
a build chamber including a cavity receiving at least a portion of the nozzle, the cavity having a predetermined pressure.

2. The additive manufacturing system of claim 1, further comprising:
at least one sensor one of positioned within or in communication the material conduit; and
at least one heater one of positioned within or in communication with the material conduit.

3. The additive manufacturing system of claim 2, further comprising:
at least one computing device operably connected to each of the at least one sensor and the at least one heater, the at least one computing device adjusting build characteristics of a component built within the build chamber using the build material by performing processes including:
determining a first temperature of the build material flowing through the first section of the material conduit;
determining a second temperature of the build material flowing through the second section of the material conduit;
calculating a cooling rate for the build material based on the first temperature and the second temperature; and
one of:
increasing the temperature of the build material flowing through the second section of the material conduit, via the at least one heater, in response to the calculated cooling rate for the build material being higher than a predetermined cooling rate for the build material, or
decreasing the temperature of the build material flowing through the second section of the material conduit in response to the calculated cooling rate for the build material being lower than the predetermined cooling rate for the build material.

4. The additive manufacturing system of claim 3, wherein increasing the temperature of the build material flowing through the second section of the material conduit further includes:
reducing the calculated cooling rate for the build material to equal the predetermined cooling rate for the build material; and
increasing a size of the build material flowing through the second section of the material conduit.

5. The additive manufacturing system of claim 4, wherein decreasing the temperature of the build material flowing through the second section of the material conduit further includes:
increasing the calculated cooling rate for the build material to equal the predetermined cooling rate for the build material; and
decreasing the size of the build material flowing through the second section of the material conduit.

6. The additive manufacturing system of claim 3, wherein decreasing the temperature of the build material flowing through the second section of the material conduit further includes at least one of:
reducing an amount of heat supplied to the material conduit via the at least one heater, or
increasing an amount of the coolant material supplied to the material conduit via the coolant conduit.

7. The additive manufacturing system of claim 3, wherein the processes performed by the at least one computing device to adjusting the build characteristics of the component built within the build chamber using the build material further includes:
preheating the material conduit, via the at least one heater, prior to flowing the build material from the material supply to the second section of the material conduit.

8. The additive manufacturing system of claim 1, wherein the predetermined pressure is less than atmospheric pressure.

9. The additive manufacturing system of claim 1, wherein the first section of the material conduit is formed from ceramic and the second section of the material conduit is formed from a metal.

10. The additive manufacturing system of claim 1, further comprising:
a supplemental material supply including a supplemental build material; and
a supplemental material conduit in fluid communication with the supplemental material supply and the material conduit, the supplemental material conduit providing supplemental build material to the material conduit.

11. The additive manufacturing system of claim 1, further comprising:
a supplemental material supply including a supplemental build material;
a supplemental material conduit in fluid communication with the supplemental material supply; and
a supplemental nozzle in direct fluid communication with the supplemental material conduit, at least a portion of the supplemental nozzle positioned within the cavity of the build chamber, adjacent the nozzle.

12. The additive manufacturing system of claim 1, wherein the build material includes one of a metal, a metal-alloy, or polymers.

13. The additive manufacturing system of claim 1, wherein:
the build material flowing through the first section of the material conduit is in at least one of a vapor state or the liquid state, and
the build material flowing through the second section of the material conduit is in at least one of the liquid state or a solid state.

14. A method of forming a component using an additive manufacturing system, the method comprising:
flowing a build material through a first section of a material conduit of the additive manufacturing system;
flowing the build material through a second section of the material conduit to a nozzle of the additive manufacturing system, the second section of the material conduit in fluid communication with and positioned between the first section of the material conduit and the nozzle,
wherein at least a portion of the build material flowing through the second section is in a liquid state; and
dispersing the build material from the nozzle onto a build substrate positioned within a cavity of a build chamber of the additive manufacturing system, the cavity having a predetermined pressure.

15. The method of claim 14 further comprising:
converting the build material from a vapor state to one of:
the liquid state in the second section of the material conduit, or
a combination of the liquid state and a solid state in the second section of the material conduit.

16. The method of claim 15, wherein the converting of the build material from the vapor state further includes:
cooling the build material flowing through the second section of the material conduit to a predetermined temperature prior to the build material being dispersed from the nozzle of the additive manufacturing system.

17. The method of claim 15, further comprising:
determining a first temperature of the build material flowing through the first section of the material conduit;
determining a second temperature of the build material flowing through the second section of the material conduit;
calculating a cooling rate for the build material based on the determined first temperature and the determined second temperature; and
one of:
increasing the temperature of the build material flowing through the second section of the material conduit in response to the calculated cooling rate for the build material being higher than a predetermined cooling rate for the build material, or
decreasing the temperature of the build material flowing through the second section of the material conduit in response to the calculated cooling rate for the build material being lower than the predetermined cooling rate for the build material.

18. The method of claim 17, wherein the increasing of the temperature of the build material flowing through the second section of the material conduit further includes:
reducing the calculated cooling rate for the build material to equal the predetermined cooling rate for the build material; and
increasing a size of the build material flowing through the second section of the material conduit in the liquid state and the solid state.

19. The method of claim 18, wherein the decreasing of the temperature of the build material flowing through the second section of the material conduit further includes:
increasing the calculated cooling rate for the build material to equal the predetermined cooling rate for the build material; and
decreasing the size of the build material flowing through the second section of the material conduit in the liquid state and the solid state.

20. The method of claim 17, wherein the decreasing of the temperature of the build material flowing through the second section of the material conduit further includes at least one of:
reducing an amount of heat supplied to the second section of the material conduit, or
increasing an amount of a coolant material supplied to the material conduit via a coolant conduit of the additive manufacturing system, the coolant conduit in fluid communication with the second section of the material conduit.
